(19) United States
(12) Patent Application Publication
(10) Pub. No.: US 2015/0074823 A1
(43) Pub. Date: Mar. 12, 2015

(54) SERVER, TERMINAL AND DIGITAL COPYRIGHT MANAGEMENT METHOD

(71) Applicants: Peking University Founder Group Co., Ltd., Beijing (CN); Founder Information Industry Group, Beijing (CN); Founder Apabi Technology Limited, Beijing (CN)

(72) Inventors: Haitao WANG, Beijing (CN); Xiaolei LI, Beijing (CN); Jingshan MA, Beijing (CN)

(73) Assignees: Peking University Founder Group Co., Ltd., Beijing (CN); Founder Information Industry Group, Beijing (CN); Founder Apabi Technology Limited, Beijing (CN)

(21) Appl. No.: 14/092,566

(22) Filed: Nov. 27, 2013

(30) Foreign Application Priority Data
Sep. 11, 2013 (CN) 201310410603.4

(51) Int. Cl. G06F 21/10; H04L 29/06

(52) U.S. Cl. CPC G06F 21/105; H04L 63/08
USPC 726/28

(57) ABSTRACT

The present invention provides a server comprising: a selection unit configured to select a target content from each digital file among a plurality of digital files according to a selection instruction received from a terminal; an extraction unit configured to extract privilege information corresponding to the target content from file key information corresponding to each digital file among the plurality of digital files, so as to obtain a plurality of privilege information; an authorization information generation unit configured to generate authorization information according to the plurality of the privilege information; and a processing unit configured to, when an authorization request is received from the terminal, transmit the authorization information to the terminal so that the terminal performs predetermined operations on the target content according to the authorization information. The present invention further provides a terminal and a digital copyright management method.

### TECHNICAL FIELD

The present invention relates to the field of digital copyright management, in particular to a server, a terminal and a digital copyright management method.

### BACKGROUND

Along with the development of network technologies and digital publishing technologies and the prevalence of terminal devices, there is an increasing demand for a user to acquire a part of concerned digital contents from different sources, and for a content provider to provide different privileges for different parts of the digital contents. In most cases, the digital contents from the same source are authorized so as to apply the digital contents, and this application lacks support for personalized use of the digital contents. Such a mode of authorizing the digital contents from the same source cannot be used to manage the rights to use the digital contents and control the use thereof in a more fine-grained manner, so it is unable to meet the user's requirements on the application of the digital contents from multiple sources. In order to meet the personalized demands of the user and to achieve business models such as “authorization for multiple sources”, fine-grained copyright protection is required for the digital contents from multiple sources.

Currently, some fine-grained copyright protection schemes have been proposed in the industry, mainly including the following two kinds. One kind of the schemes includes managing a single file by using a specific file format, the file being encrypted by paging the contents with different privileges according to the characteristics of the file format. According to such a policy, a document is encrypted and stored as a whole, and merely paged logically. When using the document, range control is performed at a software layer. The other kind includes decrypting different files of the digital contents, extracting the decrypted contents within different page ranges, recombining several extracted chapters to form a new file, and then encrypting the new file. The essence of these two kinds of schemes is to authorize and control the paging of the content from a single source. However, the first kind of schemes cannot be used to meet the requirement on recombining the digital contents from multiple sources. The second kind of schemes, which is inflexible, can be used to recombine the digital contents but a new file must be generated every time, and for different needs, several new files and corresponding keys must be managed. Meanwhile, due to the decryption of the file, the content security will be affected, and the processing and operating cost will be increased remarkably.

Hence, a new scheme is required so as to solve at least one of the above-mentioned problems.

### SUMMARY

An object of the present invention is to provide a new scheme so as to authorize digital contents from multiple sources, to reduce unnecessary influences on a user while ensuring security of the digital contents, to reduce the processing and operating cost, and to meet the user's demands on personalized application of the digital contents.

In one aspect, the present invention provides a server, comprises: a selection unit configured to select a target content from each digital file among a plurality of digital files according to a selection instruction received from a terminal; an extraction unit configured to extract privilege information corresponding to the target content from file key information corresponding to each digital file among the plurality of digital files, so as to obtain a plurality of privilege information; an authorization information generation unit configured to generate authorization information according to the plurality of privilege information; and a processing unit configured to, when an authorization request is received from the terminal, transmit the authorization information to the terminal so that the terminal performs predetermined operations on the target contents according to the authorization information.

In this technical solution, the target content may be a part of or all of the contents selected from each digital file, and the contents may be selected according to a page range. Hence, a user can select the contents of interest from the plurality of digital files. The server will extract the privilege information corresponding to the target content selected by the user, and the privilege information may be extracted according to the page range. Then, the server will combine a plurality of extracted privilege information into the authorization information. After receiving the authorization information, the terminal may perform the predetermined operations on the content of interest selected by the user from the plurality of digital files according to the authorization information. As a result, it is able to reduce unnecessary influences on the user while ensuring security of the digital contents, to reduce the processing and operating cost, and to meet the user's demands on personalized application of the digital contents.

Preferably, the authorization information may further include a usage privilege (e.g., a reading privilege, a printing privilege and a copying privilege), a unique identifier of the file, an encryption key of the file, check information of the authorized file and so on. The predetermined operation includes opening, reading, printing and copying.

Preferably, the server further comprises an acquisition unit configure to acquire first identification information of the terminal. The authorization information generation unit is further configured to generate the authorization information according to the first identification information and the plurality of privilege information. The processing unit is further configured to, when receiving the authorization request from any terminal, parse second identification information included in the authorization request from any terminal, determine whether or not the second identification information is coincident with the first identification information, and if yes, transmit the authorization information to the terminal so that the terminal performs the predetermined operations on the target contents according to the authorization information.

In this technical solution, prior to transmitting the authorization information, the server will authenticate the terminal that transmits the request, and merely transmit the authorization information to the authenticated terminal. As a result, it is able to ensure the security of the digital contents.

In the above technical solution, preferably, the server further comprises a notification unit configured to, after the authorization information is generated, notify the terminal to acquire the authorization information and download the plurality of digital files.

In this technical solution, after the server has prepared the authorization information, it will notify the corresponding terminal to acquire the authorization information and download the digital files. As a result, in the case that there are the digital files and the authorization information corresponding to the target contents selected by the user, the target contents can be applied by the terminal.

According to another aspect of the present invention, it is provided a terminal comprises an interaction unit configured to receive authorization information transmitted by a server, the authorization information including privilege information corresponding to a target content selected from each digital file among a plurality of digital files; and a parsing unit configured to parse the privilege information corresponding to each target content according to the authorization information, and extract each target content from the digital file corresponding to the target content according to the privilege information so as to perform predetermined operations on the target contents.

In this technical solution, the target contents may be a part of or all of the contents selected from each digital file, and the contents may be selected according to a page range. Hence, a user can select the contents of interest from a plurality of digital files. The server will extract the privilege information corresponding to the target content selected by the user, and the privilege information may be extracted according to the page range. Then, the server will combine a plurality of extracted privilege information into the authorization information. After receiving the authorization information, the terminal may perform the predetermined operations on the contents of interest selected by the user from the plurality of digital files according to the authorization information. As a result, it is able to reduce unnecessary influences on the user while ensuring security of the digital contents, to reduce the processing and operating cost, and to meet the user's demands on personalized application of the digital contents.

Preferably, the authorization information may further include a usage privilege (e.g., a reading privilege, a printing privilege and a copying privilege), a unique identifier of the file, an encryption key of the file, and check information of the authorized file. The predetermined operation includes opening, reading, printing, copying and so on.

In the above technical solution, preferably, the interaction unit is further configured to, when receiving a command for acquiring the identification information of the terminal from the server, transmit the identification information of the terminal to the server, so that the server generates the authorization information according to the identification information and the privilege information.

In this technical solution, when the terminal receives the command for acquiring the identification information from the server, it will transmit the identification information to the server, so that the server authenticates the terminal that transmits the request. As a result, it is able to ensure the security of the digital copyright contents.

In the above technical solution, preferably, the interaction unit is further configured to transmit the authorization request to the server and receive, from the server, a notification to acquire the authorization information and download the plurality of digital files. The terminal further comprises a downloading unit configured to, when receiving the download notification from the server, download the digital files corresponding to the target contents.

In this technical solution, after the terminal receives the notification from the server, it will acquire the authorization information and downloads the digital files. As a result, in the case that there are the digital files and the authorization information corresponding to the target contents selected by the user, the terminal can extract the target contents from the digital files according to the authorization information and then apply the target contents.

In the above technical solution, preferably, the parsing unit further comprises a combination unit configured to combine the parsed target contents in a predetermined order, and perform predetermined operations on the combined target contents.

In this technical solution, when selecting the contents of the plurality of digital files, the user may set the combination order. Correspondingly, the terminal will combine the target contents in the predetermined order, and the user may perform predetermined operations on the combined target contents.

For example, pages 1 to 20 in a digital file A are selected and marked as a, pages 4 to 28 in a digital file B are selected and marked as b, pages 50 to 80 in a digital file C are selected and marked as c, and the sequence of sorting is determined as abc. After the server receives a selection instruction, it will extract the privilege information of pages 1 to 20 (i.e., a) from file key information of the digital file A, extract the privilege information pages 4 to 28 (i.e., b) from file key information of the digital file B, and extract the privilege information of pages 50 to 80 (i.e., c) from file key information of the digital file C. The extracted three pieces of privilege information are combined to generate the authorization information, which is transmitted to the terminal. Then, the terminal can extract pages 1-20, pages 4-28 and pages 50-80 from the downloaded digital files A, B and C according to the authorization information respectively, and combine them into a new file. In the new file, pages a, b and c are arranged sequentially. The user can perform the operations, such as printing, copying and viewing, on the new file.

According to another aspect of the present invention, it is provided a digital copyright management system, the system comprises a server as mentioned in any one of the above technical solutions and a terminal as mentioned in any one of the above technical solutions.

According to another aspect of the present invention, it is provided a digital copyright management method, comprises: selecting a target content from each digital file among a plurality of digital files according to a selection instruction received from a terminal; extracting privilege information corresponding to the target contents from file key information corresponding to each digital file among the plurality of digital files, so as to obtain a plurality of privilege information; generating authorization information according to the plurality of privilege information; when an authorization request is received from the terminal, transmitting the authorization information to the terminal so that the terminal performs predetermined operations on the target content according to the authorization information.

In this technical solution, the target contents may be a part of or all of the contents selected from each digital file, and the contents may be selected according to a page range. Hence, a user can select the contents of interest from the plurality of digital files. The server will extract the privilege information corresponding to the target contents selected by the user, and the privilege information may be extracted according to the page range. Then, the server will combine the plurality of extracted privilege information into the authorization information. After receiving the authorization information, the terminal may perform the predetermined operations on the contents of interest selected by the user from the plurality of digital files according to the authorization information. As a result, it is able to reduce unnecessary influences on the user while ensuring security of the digital contents, to reduce the processing and operating cost, and to meet the user's demands on personalized application of the digital contents.

Preferably, the authorization information may further include a usage privilege (e.g., a reading privilege, a printing privilege and a copying privilege), a unique identifier of the file, an encryption key of the file, and check information of the authenticated file. The predetermined operations include opening, reading, printing and copying.

In the above technical solution, the method further comprises acquiring first identification information of the terminal, generating the authorization information according to the first identification information and the plurality of privilege information, when receiving the authorization request from any terminal, parsing second identification information included in the authorization request, determining whether or not the second identification information is coincident with the first identification information, and if yes, transmitting the authorization information to the terminal so that the terminal performs the predetermined operations on the target contents according to the authorization information.

In this technical solution, prior to transmitting the authorization information, the server will authenticate the terminal that transmits the request, and merely transmit the authorization information to the authenticated terminal. As a result, it is able to ensure the security of the digital contents.

In the above technical solution, preferably, the method further comprises, after the authorization information is generated, notifying the terminal to acquire the authorization information and download the digital files.

In this technical solution, after the server has prepared the authorization information, it will notify the corresponding terminal to acquire the authorization information and download the digital files. As a result, in the case that there are the digital files and the authorization information corresponding to the target contents selected by the user, the target contents can be applied by the terminal.

According to another aspect of the present invention, it is provided a digital copyright management method comprises: receiving authorization information transmitted by a server, wherein the authorization information include privilege information corresponding to a target content selected from each digital file among a plurality of digital files; and parsing the privilege information corresponding to each target content according to the authorization information and extracting each target content from the digital file corresponding to the target content according to the privilege information so as to perform predetermined operations on the target contents.

The target contents may be a part of or all of the contents selected from each digital file, and the contents may be selected according to a page range. Hence, a user can select the contents of interest from a plurality of digital files. The server will extract the privilege information corresponding to the target content selected by the user, and the privilege information may be extracted according to the page range. Then, the server will combine a plurality of the extracted privilege information into the authorization information. After receiving the authorization information, the terminal may perform the predetermined operations on the contents of interest selected by the user from the plurality of digital files according to the authorization information. As a result, it is able to reduce unnecessary influences on the user while ensuring security of the digital contents, to reduce the processing and operating cost, and to meet the user's demands on personalized application of the digital contents.

Preferably, the authorization information may further include a usage privilege (e.g., a reading privilege, a printing privilege and a copying privilege), a unique identifier of the file, an encryption key of the file, and check information of the authorized file. The predetermined operation includes opening, reading, printing, copying and so on.

Preferably, the method further comprises, when receiving a command for acquiring the identification information of the terminal from the server, transmitting the identification information of the terminal to the server, so that the server generates the authorization information according to the identification information and the privilege information.

When the terminal receives the command for acquiring the identification information from the server, it will transmit the identification information to the server, so that the server authenticates the terminal that transmits the request. As a result, it is able to ensure the security of the digital copyright contents.

Preferably, the method further comprises: transmitting the authorization request to the server; receiving, from the server, a notification to acquire the authorization information and download the plurality of digital files; and when receiving the download notification from the server, downloading the digital files corresponding to the target contents.

After the terminal receives the notification from the server, it will acquire the authorization information and download the digital files. As a result, in the case that there are the digital files and the authorization information corresponding to the target contents selected by the user, the terminal can extract the target contents from the digital files according to the authorization information and then apply the target contents.

Preferably, the method further comprises combining the parsed target contents in a predetermined order, and performing the predetermined operations on the combined target contents.

When selecting the contents of the plurality of digital files, the user may set the combination order. Correspondingly, the terminal will combine the target contents in the predetermined order, and the user may perform the predetermined operations on the combined target contents.

For example, pages 1 to 20 in a digital file A are selected and marked as a, pages 4 to 28 in a digital file B are selected and marked as b, pages 50 to 80 in a digital file C are selected and marked as c, and the sequence of sorting is determined as abc. After the server receives a selection instruction, it will extract the privilege information of pages 1 to 20 (i.e., a) from the file key information of the digital file A, extract the privilege information pages 4 to 28 (i.e., b) from the file key information of the digital file B, and extract the privilege information of pages 50 to 80 (i.e., c) from the file key information of the digital file C. The extracted three pieces of privilege information are combined to generate the authorization information, which is transmitted to the terminal. Then, the terminal can extract pages 1-20, pages 4-28 and pages 50-80 from the downloaded digital files A, B and C according to the authorization information respectively, and combine them into a new file. In the new file, pages a, b and c are arranged sequentially. The user can perform the operations, such as printing, copying and viewing, on the new file.

According to the present invention, it is able to authorize the contents from multiple sources, to reduce unnecessary influences on a user while ensuring security of the digital contents, to reduce the processing and operating cost, and to meet the user's demands on personalized application of the digital contents.

### BRIEF DESCRIPTION OF THE DRAWINGS

FIG. 1 is a block diagram of a server according to one embodiment of the present invention;

FIG. 2 is a block diagram of a terminal according to one embodiment of the present invention;

FIG. 3 is a block diagram of a digital copyright management system according to one embodiment of the present invention;

FIG. 4 is a flow chart of a digital copyright management method according to one embodiment of the present invention;

FIG. 5 is a flow chart of a digital copyright management method according to another embodiment of the present invention;

FIG. 6 is a flow chart of a digital copyright management method according to yet another embodiment of the present invention; and

FIG. 7 is a block diagram of a digital copyright management system according to another embodiment of the present invention.

### DETAILED DESCRIPTION

To make the objects, the features and the advantages of the present invention more apparent, the present invention will be described hereinafter in conjunction with the drawings and the embodiments. It is to be noted that, if without any conflict, the embodiments and the features therein may be combined with each other.

The following descriptions are merely for illustrative purpose, but cannot be used to limit the present invention.

FIG. 1 is a block diagram of a server according to one embodiment of the present invention.

As shown in FIG. 1, the server 100 comprises a selection unit 102 configured to select a target content from each digital file among a plurality of digital files according to a selection instruction received from a terminal; an extraction unit 104 configured to extract privilege information corresponding to the target content from file key information corresponding to each digital file among the plurality of digital files, so as to obtain a plurality of privilege information; an authorization information generation unit 106 configured to generate authorization information according to the plurality of privilege information; and a processing unit 108 configured to, when an authorization request is received from the terminal, transmit the authorization information to the terminal so that the terminal performs predetermined operations on the target contents according to the authorization information.

In this technical solution, the target content may be a part of or all of the contents selected from each digital file, and the contents may be selected according to a page range. Hence, a user can select the contents of interest from the plurality of digital files. The server will extract the privilege information corresponding to the target content selected by the user, and the privilege information may be extracted according to the page range. Then, the server will combine a plurality of extracted privilege information into the authorization information. After receiving the authorization information, the terminal may perform the predetermined operations on the content of interest selected by the user from the plurality of digital files according to the authorization information. As a result, it is able to reduce unnecessary influences on the user while ensuring security of the digital contents, to reduce the processing and operating cost, and to meet the user's demands on personalized application of the digital contents.

Preferably, the authorization information may further include a usage privilege (e.g., a reading privilege, a printing privilege and a copying privilege), a unique identifier of the file, an encryption key of the file, check information of the authorized file and so on. The predetermined operation includes opening, reading, printing and copying.

Preferably, the server 100 further comprises an acquisition unit 110 configure to acquire first identification information of the terminal. The authorization information generation unit 106 is further configured to generate the authorization information according to the first identification information and the plurality of privilege information. The processing unit 108 is further configured to, when receiving the authorization request from any terminal, parse second identification information included in the authorization request from any terminal, determine whether or not the second identification information is coincident with the first identification information, and if yes, transmit the authorization information to the terminal so that the terminal performs the predetermined operations on the target contents according to the authorization information.

In this technical solution, prior to transmitting the authorization information, the server 100 will authenticate the terminal that transmits the request, and merely transmit the authorization information to the authenticated terminal. As a result, it is able to ensure the security of the digital contents.

In the above technical solution, preferably, the server 100 further comprises a notification unit 112 configured to, after the authorization information is generated, notify the terminal to acquire the authorization information and download the plurality of digital files.

In this technical solution, after the server has prepared the authorization information, it will notify the corresponding terminal to acquire the authorization information and download the digital files. As a result, in the case that there are the digital files and the authorization information corresponding to the target contents selected by the user, the target contents can be applied by the terminal.

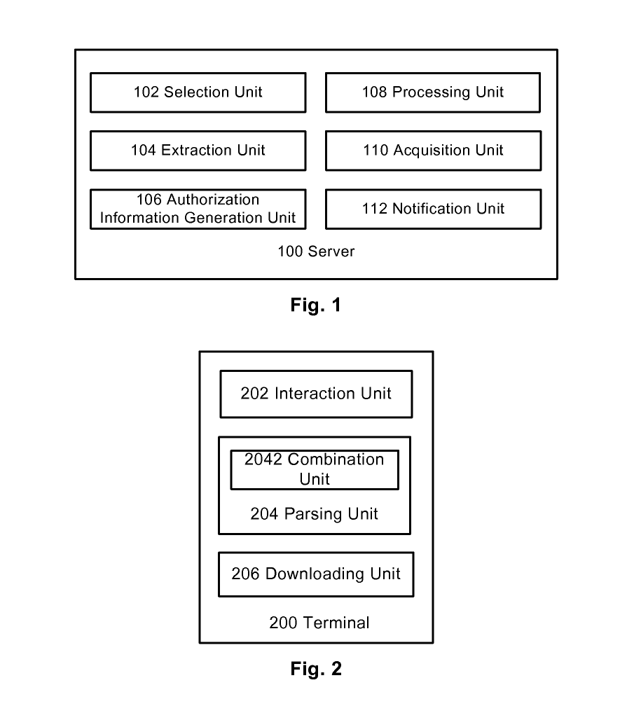

FIG. 2 is a block diagram of a terminal according to one embodiment of the present invention.

As shown in FIG. 2, the terminal 200 comprises an interaction unit 202 configured to receive authorization information transmitted by a server, the authorization information including privilege information corresponding to a target content selected from each digital file among a plurality of digital files; and a parsing unit 204 configured to parse the privilege information corresponding to each target content according to the authorization information, and extract each target content from the digital file corresponding to the target content according to the privilege information so as to perform predetermined operations on the target contents.

In this technical solution, the target contents may be a part of or all of the contents selected from each digital file, and the contents may be selected according to a page range. Hence, a user can select the contents of interest from a plurality of digital files. The server will extract the privilege information corresponding to the target content selected by the user, and the privilege information may be extracted according to the page range. Then, the server will combine a plurality of extracted privilege information into the authorization information. After receiving the authorization information, the terminal may perform the predetermined operations on the contents of interest selected by the user from the plurality of digital files according to the authorization information. As a result, it is able to reduce unnecessary influences on the user while ensuring security of the digital contents, to reduce the processing and operating cost, and to meet the user's demands on personalized application of the digital contents.

Preferably, the authorization information may further include a usage privilege (e.g., a reading privilege, a printing privilege and a copying privilege), a unique identifier of the file, an encryption key of the file, and check information of the authorized file. The predetermined operation includes opening, reading, printing, copying and so on.

In the above technical solution, preferably, the interaction unit 202 is further configured to, when receiving a command for acquiring the identification information of the terminal from the server, transmit the identification information of the terminal to the server, so that the server generates the authorization information according to the identification information and the privilege information.

In this technical solution, when the terminal receives the command for acquiring the identification information from the server, it will transmit the identification information to the server, so that the server authenticates the terminal that transmits the request. As a result, it is able to ensure the security of the digital copyright contents.

In the above technical solution, preferably, the interaction unit 202 is further configured to transmit the authorization request to the server and receive, from the server, a notification to acquire the authorization information and download the plurality of digital files. The terminal 200 further comprises a downloading unit 206 configured to, when receiving the download notification from the server, download the digital files corresponding to the target contents.

In this technical solution, after the terminal 200 receives the notification from the server, it will acquire the authorization information and downloads the digital files. As a result, in the case that there are the digital files and the authorization information corresponding to the target contents selected by the user, the terminal 200 can extract the target contents from the digital files according to the authorization information and then apply the target contents.

In the above technical solution, preferably, the parsing unit 204 further comprises a combination unit 2042 configured to combine the parsed target contents in a predetermined order, and perform predetermined operations on the combined target contents.

In this technical solution, when selecting the contents of the plurality of digital files, the user may set the combination order. Correspondingly, the terminal will combine the target contents in the predetermined order, and the user may perform predetermined operations on the combined target contents.

For example, pages 1 to 20 in a digital file A are selected and marked as a, pages 4 to 28 in a digital file B are selected and marked as b, pages 50 to 80 in a digital file C are selected and marked as c, and the sequence of sorting is determined as abc. After the server receives a selection instruction, it will extract the privilege information of pages 1 to 20 (i.e., a) from file key information of the digital file A, extract the privilege information pages 4 to 28 (i.e., b) from file key information of the digital file B, and extract the privilege information of pages 50 to 80 (i.e., c) from file key information of the digital file C. The extracted three pieces of privilege information are combined to generate the authorization information, which is transmitted to the terminal. Then, the terminal can extract pages 1-20, pages 4-28 and pages 50-80 from the downloaded digital files A, B and C according to the authorization information respectively, and combine them into a new file. In the new file, pages a, b and c are arranged sequentially. The user can perform the operations, such as printing, copying and viewing, on the new file.

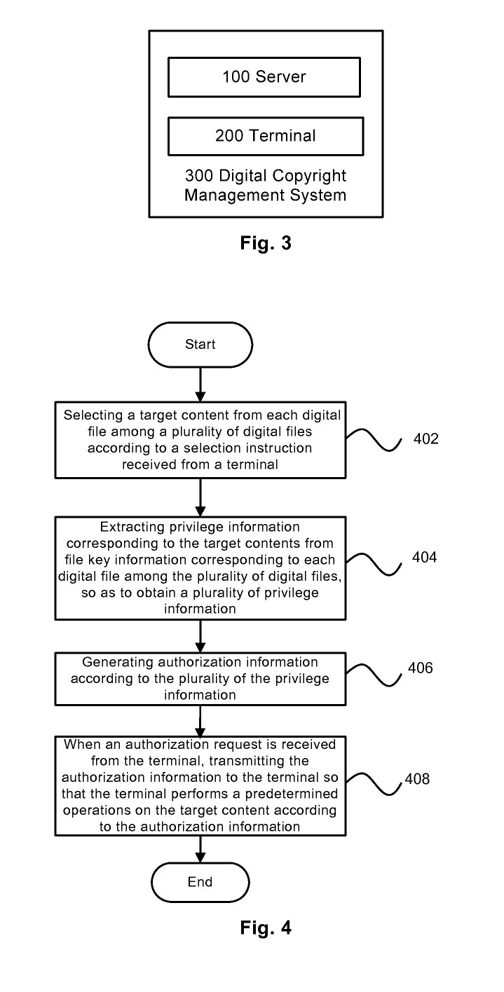

FIG. 3 is a block diagram of a digital copyright management system according to one embodiment of the present invention.

As shown in FIG. 3, the digital copyright management system 300 according to embodiments of the present invention comprises the server 100 as mentioned in any one of the above technical solutions and the terminal 200 as mentioned in any one of the above technical solutions.

FIG. 4 is a flow chart of a digital copyright management method according to one embodiment of the present invention.

As shown in FIG. 4, the digital copyright management method comprises: Step 402, selecting a target content from each digital file among a plurality of digital files according to a selection instruction received from a terminal; Step 404, extracting privilege information corresponding to the target contents from file key information corresponding to each digital file among the plurality of digital files, so as to obtain a plurality of privilege information; Step 406, generating authorization information according to the plurality of privilege information; and Step 408, when an authorization request is received from the terminal, transmitting the authorization information to the terminal so that the terminal performs predetermined operations on the target content according to the authorization information.

In this technical solution, the target contents may be a part of or all of the contents selected from each digital file, and the contents may be selected according to a page range. Hence, a user can select the contents of interest from the plurality of digital files. The server will extract the privilege information corresponding to the target contents selected by the user, and the privilege information may be extracted according to the page range. Then, the server will combine the plurality of extracted privilege information into the authorization information. After receiving the authorization information, the terminal may perform the predetermined operations on the contents of interest selected by the user from the plurality of digital files according to the authorization information. As a result, it is able to reduce unnecessary influences on the user while ensuring security of the digital contents, to reduce the processing and operating cost, and to meet the user's demands on personalized application of the digital contents.

Preferably, the authorization information may further include a usage privilege (e.g., a reading privilege, a printing privilege and a copying privilege), a unique identifier of the file, an encryption key of the file, and check information of the authenticated file. The predetermined operations include opening, reading, printing and copying.

In the above technical solution, preferably, Step 404 further comprises acquiring first identification information of the terminal. Step 406 further comprises generating the authorization information according to the first identification information and the plurality of privilege information. Step 408 further comprises, when receiving the authorization request from any terminal, parsing second identification information included in the authorization request, determining whether or not the second identification information is coincident with the first identification information, and if yes, transmitting the authorization information to the terminal so that the terminal performs the predetermined operations on the target contents according to the authorization information.

In this technical solution, prior to transmitting the authorization information, the server will authenticate the terminal that transmits the request, and merely transmit the authorization information to the authenticated terminal. As a result, it is able to ensure the security of the digital contents.

In the above technical solution, preferably, subsequent to Step 406, the method further comprises, after the authorization information is generated, notifying the terminal to acquire the authorization information and download the digital files.

In this technical solution, after the server has prepared the authorization information, it will notify the corresponding terminal to acquire the authorization information and download the digital files. As a result, in the case that there are the digital files and the authorization information corresponding to the target contents selected by the user, the target contents can be applied by the terminal.

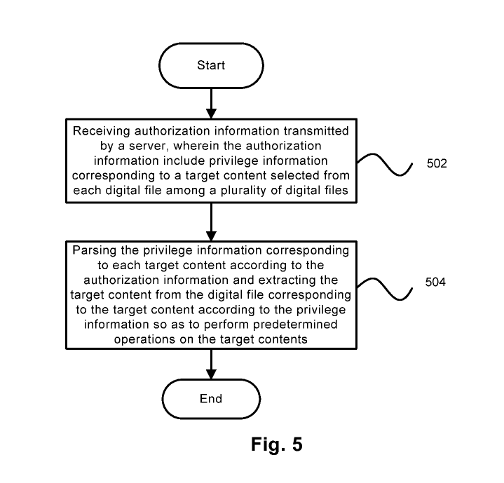

FIG. 5 is a flow chart of a digital copyright management method according to another embodiment of the present invention.

As shown in FIG. 5, the digital copyright management method comprises: Step 502, receiving authorization information transmitted by a server, wherein the authorization information include privilege information corresponding to a target content selected from each digital file among a plurality of digital files; and Step 504, parsing the privilege information corresponding to each target content according to the authorization information and extracting each target content from the digital file corresponding to the target content according to the privilege information so as to perform predetermined operations on the target contents.

The target contents may be a part of or all of the contents selected from each digital file, and the contents may be selected according to a page range. Hence, a user can select the contents of interest from a plurality of digital files. The server will extract the privilege information corresponding to the target content selected by the user, and the privilege information may be extracted according to the page range. Then, the server will combine a plurality of the extracted privilege information into the authorization information. After receiving the authorization information, the terminal may perform the predetermined operations on the contents of interest selected by the user from the plurality of digital files according to the authorization information. As a result, it is able to reduce unnecessary influences on the user while ensuring security of the digital contents, to reduce the processing and operating cost, and to meet the user's demands on personalized application of the digital contents.

Preferably, the authorization information may further include a usage privilege (e.g., a reading privilege, a printing privilege and a copying privilege), a unique identifier of the file, an encryption key of the file, and check information of the authorized file. The predetermined operation includes opening, reading, printing, copying and so on.

Preferably, prior to Step 502, the method further comprises, when receiving a command for acquiring the identification information of the terminal from the server, transmitting the identification information of the terminal to the server, so that the server generates the authorization information according to the identification information and the privilege information.

When the terminal receives the command for acquiring the identification information from the server, it will transmit the identification information to the server, so that the server authenticates the terminal that transmits the request. As a result, it is able to ensure the security of the digital copyright contents.

Preferably, prior to Step 502, the method further comprises: transmitting the authorization request to the server; receiving, from the server, a notification to acquire the authorization information and download the plurality of digital files; and when receiving the download notification from the server, downloading the digital files corresponding to the target contents.

After the terminal receives the notification from the server, it will acquire the authorization information and download the digital files. As a result, in the case that there are the digital files and the authorization information corresponding to the target contents selected by the user, the terminal can extract the target contents from the digital files according to the authorization information and then apply the target contents.

Preferably, Step 504 further comprises combining the parsed target contents in a predetermined order, and performing the predetermined operations on the combined target contents.

When selecting the contents of the plurality of digital files, the user may set the combination order. Correspondingly, the terminal will combine the target contents in the predetermined order, and the user may perform the predetermined operations on the combined target contents.

For example, pages 1 to 20 in a digital file A are selected and marked as a, pages 4 to 28 in a digital file B are selected and marked as b, pages 50 to 80 in a digital file C are selected and marked as c, and the sequence of sorting is determined as abc. After the server receives a selection instruction, it will extract the privilege information of pages 1 to 20 (i.e., a) from the file key information of the digital file A, extract the privilege information pages 4 to 28 (i.e., b) from the file key information of the digital file B, and extract the privilege information of pages 50 to 80 (i.e., c) from the file key information of the digital file C. The extracted three pieces of privilege information are combined to generate the authorization information, which is transmitted to the terminal. Then, the terminal can extract pages 1-20, pages 4-28 and pages 50-80 from the downloaded digital files A, B and C according to the authorization information respectively, and combine them into a new file. In the new file, pages a, b and c are arranged sequentially. The user can perform the operations, such as printing, copying and viewing, on the new file.

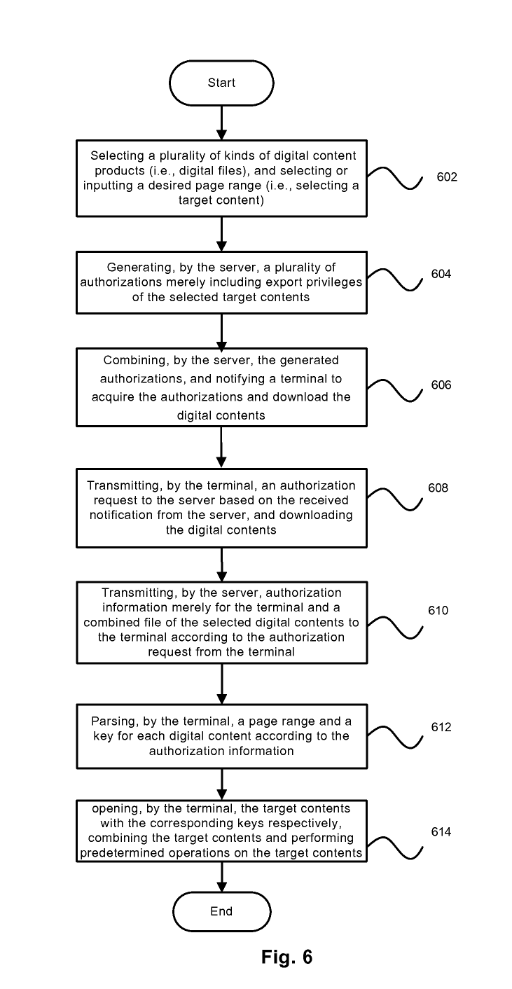

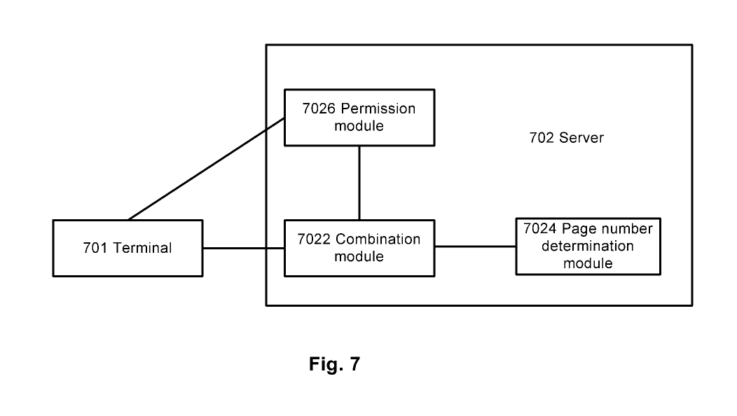

The present invention will be described hereinafter in conjunction with FIGS. 6 and 7.

FIG. 6 is a flow chart of a digital copyright management method according to yet another embodiment of the present invention.

As shown in FIG. 6, the digital copyright management method comprises the following steps.

Step 602: selecting a plurality of kinds of digital content products (i.e., a plurality of digital files), and selecting or inputting a desired page range (i.e., selecting a target content). When selecting the target content, a server may preferably check the selected different page ranges for the plurality of digital files with the recorded page range of the file so as to determine whether or not the selected page range is within the page range of the digital file.

Step 604: generating, by the server, a plurality of authorizations merely including export privileges of the selected target contents.

Step 606: combining, by the server, the generated authorizations, and notifying a terminal to acquire the authorizations and download the digital content products. The digital content products are encrypted, so the terminal needs to be authorized so as to apply them.

Step 608: transmitting, by the terminal, an authorization request to the server after receiving a notification from the server, and downloading the digital content products.

Step 610: transmitting, by the server, authorization information merely for the terminal and a combined file of the selected digital content products according to the authorization request from the terminal.

Step 612: parsing, by the terminal, a page range and a key for each digital content product according to the authorization information.

Step 614: opening the target contents with the corresponding keys respectively, combining the target contents and performing predetermined operations, such as printing, using and copying, on the target contents. If the user has set an arrangement order of the target contents, the terminal may further combine the target contents in the predetermined order.

A case is provided hereinafter so as to describe the above procedure.

Case: recombination and copyright management of a plurality of files in a CEBX format

For example, there are three files, i.e., Journey to the West.cebx, Romance of the Three Kingdoms.cebx, and Dream of the Red Chamber.cebx.

The user may select the digital content products of interest from the server, determine the page ranges of interest, and combining and sorting these page ranges. For example, the user may select pages 20 to 30 from Journey to the West.cebx and mark them as A, select pages 60 to 70 from Romance of the Three Kindoms.cebx and mark them as B, and select pages 90 to 95 from Dream of the Red Chamber.cebx as C, and the sorting sequence is ABC.

The server generates authorizations merely including export privileges for the pages A, B and C according to the user's selection, combines the three authorizations, and notifies the terminal to acquire the authorizations and download the three files.

The terminal requests the authorization to download the three files.

The server transmits the authorization information according to the terminal information.

The terminal parses these three files based on the authorization information to obtain the file contents of A, B and C, combines these file contents in the predetermined order to form a new file, and then performs the predetermined operations, such as printing and copying, on the new file.

FIG. 7 is a block diagram of a digital copyright management system according to another embodiment of the present invention.

As shown in FIG. 7, the digital copyright management system 700 comprises a terminal 701 and a server 702. The server 702 includes a combination module 7022 (i.e., equivalent to the selection unit), a page number determination module 7024 and a permission module 7026 (i.e., equivalent to the extraction unit, the authorization information generation unit and the processing unit).

The working process of the digital copyright management system is described hereinafter based on the modules. The user will select the digital content products of interest in the combination module 7022, determine the page ranges of interest, and combine and sort these page ranges. Preferably, the combination module 7022 asks the page number determination module 7024 to determine page ranges based on the user's selection, the page number determination module 7024 determines whether or not the selected page range is within the page range of the file and can be exported. The combination module 7022 transmits a request to the permission module 7026 for the authorizations merely including the selected page ranges. After receiving the request, the permission module 7026 records the authorizations, prepares the data and waits for issuing the authorizations. The combination module 7022 recombines these pages into a new recombined authorization guide file according to the authorizations, and notifies the terminal 701 to download the file and transmit the authorization request. The terminal 701 downloads the file and transmits the authorization request. The permission module 7022 issues the authorization for the new file to the terminal 701. After receiving the authorization, the terminal 701 parses the corresponding page ranges and the authorizations thereof, so as to obtain the new file that can be applied.

The combination module 7022, the page number determination module 7024 and the permission module 7026 may be different modules in a server, or may represent different servers. In other words, the present invention may be implemented by one server or a plurality of servers.

According to the present invention, it is able to authorize the contents from multiple sources, to reduce unnecessary influences on a user while ensuring security of the digital contents, to reduce the processing and operating cost, and to meet the user's demands on personalized application of the digital contents.

The above are merely the preferred embodiments of the present invention, and these embodiments shall not be used to limit the present invention. It should be noted that, a person skilled in the art may further make improvements and modifications without departing from the spirit and principle of the present invention, and these improvements and modifications shall also be considered as the scope of the present invention.

What is claimed is:

1. A server, comprising:
a selection unit configured to select a target content from each digital file among a plurality of digital files according to a selection instruction received from a terminal;
an extraction unit configured to extract privilege information corresponding to the target content from file key information corresponding to each digital file among the plurality of digital files, so as to obtain a plurality of privilege information;
an authorization information generation unit configured to generate authorization information according to the plurality of privilege information; and
a processing unit configured to, when an authorization request is received from the terminal, transmit the authorization information to the terminal so that the terminal performs predetermined operations on the target content according to the authorization information.

2. The server according to claim 1, further comprising:
an acquisition unit configured to acquire first identification information of the terminal,
wherein the authorization information generation unit is further configured to generate the authorization information according to the first identification information and the plurality of privilege information, and
the processing unit is further configured to, when receiving the authorization request from any terminal, parse second identification information included in the authorization request from the terminal, determine whether or not the second identification information is coincident with the first identification information, and if yes, transmit the authorization information to the terminal so that the terminal performs the predetermined operations on the target content according to the authorization information.

3. The server according to claim 1, further comprising:
a notification unit configured to, after the authorization information is generated, notify the terminal to acquire the authorization information and download the plurality of digital files.

4. A terminal, comprising:
an interaction unit configured to receive authorization information transmitted from a server, the authorization information including privilege information corresponding to a target content selected from each digital file among a plurality of digital files; and
a parsing unit configured to parse the privilege information corresponding to each target content according to the authorization information, and extract each target content from each digital file among the plurality of digital files corresponding to the target content according to the privilege information so as to perform predetermined operations on the target content.

5. The terminal according to claim 4, wherein
the interaction unit is further configured to, when receiving a command for acquiring identification information of the terminal from the server, transmit the identification information of the terminal to the server, so that the server generates the authorization information according to the identification information and the privilege information.

6. The terminal according to claim 4, wherein the interaction unit is further configured to transmit an authorization request to the server and receive, from the server, a notification to acquire the authorization information and download the plurality of digital files, and
the terminal further comprises a downloading unit configured to, when receiving the notification from the server, download the plurality of digital files corresponding to the target content.

7. The terminal according to claim 4, wherein the parsing unit further comprises a combination unit configured to combine the target content in a predetermined order, and perform the predetermined operations on the combined target content.

8. A digital copyright management method, comprising:
selecting a target content from each digital file among a plurality of digital files according to a selection instruction from a terminal;
extracting privilege information corresponding to the target content from file key information corresponding to each digital file among the plurality of digital files, so as to obtain a plurality of privilege information;
generating authorization information according to the plurality of privilege information; and
when an authorization request is received from the terminal, transmitting the authorization information to the terminal so that the terminal performs predetermined operations on the target content according to the authorization information.

9. The digital copyright management method according to claim 8, further comprising:
acquiring first identification information of the terminal;
generating the authorization information according to the first identification information and the plurality of privilege information; and
when receiving the authorization request from the terminal, parsing second identification information included in the authorization request, determining whether or not the second identification information is coincident with the first identification information, and if yes, transmitting the authorization information to the terminal so that the terminal performs the predetermined operations on the target content according to the authorization information.

10. The digital copyright management method according to claim 8, further comprising:
after the authorization information is generated, notifying the terminal to acquire the authorization information and downloading the plurality of digital files.

11. A digital copyright management method, comprising:
receiving authorization information transmitted by a server, wherein the authorization information includes privilege information corresponding to a target content selected from each digital file among a plurality of digital files; and
parsing the privilege information corresponding to each target content according to the authorization information, and extracting the target content from each digital file among the plurality of digital files corresponding to the target content according to the privilege information so as to perform predetermined operations on the target content.

12. The digital copyright management method according to claim 11, further comprising:
when receiving a command for acquiring identification information of a terminal from the server, transmitting the identification information of the terminal to the server, so that the server generates the authorization information according to the identification information and the privilege information.

13. The digital copyright management method according to claim 11, further comprising:
transmitting an authorization request to the server;
receiving, from the server, a notification to acquire the authorization information and download the plurality of digital files; and
when receiving the notification from the server, downloading the plurality of digital files corresponding to the target contents.

14. The digital copyright management method according to claim 11, further comprises:
combining the target content in a predetermined order, and performing the predetermined operations on the combined target content.
